(19) United States
(12) Patent Application Publication
(10) Pub. No.: US 2014/0012992 A1
(43) Pub. Date: Jan. 9, 2014

(54) Computational Resource Allocation System, A Code Analysis Framework, And A Method For Computational Resource Allocation System

(71) Applicant: Siemens Aktiengesellschaft, (US)

(72) Inventors: Preeti Koka, Bangalore (IN); Chaitanya Kothapalli, Bangalore (IN); Ranajoy Malakar, Bangalore (IN); Muneer Altaf Mohammad, Bangalore (IN)

(73) Assignee: Siemens Aktiengesellschaft, Munchen (DE)

(21) Appl. No.: 13/864,828

(22) Filed: Apr. 17, 2013

(30) Foreign Application Priority Data
Apr. 17, 2012 (IN) 438/KOL/2012

(51) Int. Cl. H04L 12/911

(52) U.S. Cl. CPC H04L 47/70
USPC 709/226

(57) ABSTRACT

A computational resource allocation may include a mapper and a provisioner, for cost-effective allocation of a set of information between external computational resources placed within an internet-based computing environment and internal computational resources that are at least a part of a mega computational resource placed in an intranet-based computing environment. The mapper receives a first list representing a set of information and a second list representing a set of external computational resource and a set of internal computational resources, which identify the computation requirements for computing the set of information and to map the same along with the set of information onto the set of resources using the first list and the second list, thereby generating an execution deployment plan. The provisioner receives the execution deployment plan and provides the set of information to the computational resources for processing of the set of information based thereof.

### CROSS-REFERENCE TO RELATED APPLICATIONS

This application claims priority to IN Patent Application No. 438/KOL/2012 filed Apr. 17, 2012. The contents of which is incorporated herein by reference in its entirety.

### TECHNICAL FIELD

The disclosure relates to computational resource allocation for processing a set of information. More specifically, the system relates to computational resource allocation, wherein the computational resources are placed within an intranet as well as in internet space too.

### BACKGROUND

In current scenarios, information to be processed by a computational resource is increasing leaps and bounds. To deal with such a situation, concepts of parallel processing are being used, where the processing of independent pieces of information is handled by using computation power of same computational resource. However, same computational resource can only be used if information is limited and can be processed by same computational resource, otherwise processing of independent information is further delegated to some other internal resource which may be available within a proprietary network of an user such as intranet or Virtual private network, or external resources which may be distributed in internet like cloud computing environment.

As requirement to process such information is limited, hence to buy computational resource for such computation requirements permanently is a costly affair. Hence, it is advisable to hire computational resources from external environment like internet as currently being happened in the case of cloud computing. However, hiring the computational resources beyond the computation requirements or without utilizing the internal computational resources with the proprietary network may increase cost of processing.

### SUMMARY

One embodiment provides a computational resource allocation system comprising: a mapper configured to receive a first list representative of a set of information and a second list representative of a set of external computational resource and a set of internal computational resources, to process the first list to identify the computation requirements for computing the set of information and to map the computation requirements along with the set of information onto the set of resources by using the first list and the second list for generating an execution deployment plan, a provisioner configured to receive the execution deployment plan and to provide the set of information to the computational resources in the set for processing of the set of information based on the execution deployment plan, wherein the external computational resource are placed in an internet based computing environment and the internal computational resources are at least part of a mega computational resource or placed in an intranet based computing environment.

In a further embodiment, the mapper is configured to map the first list onto the second list for mapping the set of information by firstly mapping the first list onto the internal computational resources and further onto the external computational resources on exhausting the internal computational resources.

In a further embodiment, the system further comprises an anonymizer configured to receive the execution deployment plan from the mapper, to process the execution deployment plan for identifying a part of set of information to be sent to the external computational resources, to encrypt the part of the set of information and to send the part of the set of information after encrypting to the provisioner for allocating the part of the set of information to the external computational resource for processing anonymously, wherein the provisioner is configured to provide a remaining part of the set of information, not being provided to the external computational resources, to the internal computational resources.

In a further embodiment, the anonymizer is configured to receive the part of the set of information after being processed by the external computational resources and to decrypt the part of the set of information.

In a further embodiment, the provisioner configured to receive the computation requirements for the set of information from the mapper, to interact with the external computational resources and the internal computational resources, to identify the resources available for processing the set of information based on the computational requirements, to generate the second list based on such identification and to provide the second list to the mapper.

In a further embodiment, the external based computing environment is cloud computing environment.

Another embodiment provides a code analysis framework comprising: a computational resource allocation system as disclosed above, a dependency module configured to receive a set of representations of various parts of a piece of code and configured to determine interdependency based on at least control flow or data flow between various representations of the piece of code and to collaborate the representations of parts of the piece of code into the set of information, wherein the computational resources processes the set of information to analyze the information for detecting violations of a set of rules.

In a further embodiment, the framework further comprises a representation module configured to receive the piece of code, to divide the piece of code into various parts, to the generate representations for each part of the piece of code and to provide the representations to the dependency module.

Another embodiment provides a method for allocating computational resource comprising: receiving a first list representative of a set of information and a second list representative of a set of external computational resource and a set of internal computational resources by a mapper, processing the first list to identify the computation requirements for computing the set of information, mapping the computation requirements along with the set of information onto the set of resources by using the first list and the second list and generating an execution deployment plan based on the mapping by the mapper, receiving the execution deployment plan from the mapper by a provisioner, and providing the set of information to the computational resources in the set for processing of the set of information based on the execution deployment plan, wherein the external computational resource are placed in an internet based computing environment and the internal computational resources are at least part of a mega computational resource or placed in an intranet based computing environment.

In a further embodiment, mapping the first list onto the second list for mapping the set of information by firstly mapping the first list onto the internal computational resources and further onto the external computational resources on exhausting the internal computational resources.

In a further embodiment, the method further comprises receiving the execution deployment plan from the mapper and processing the execution deployment plan for identifying a part of set of information to be sent to the external computational resources by an anonymizer, encrypting the part of the set of information and sending the part of the set of information after encrypting to the provisioner for allocating the part of the set of information to the external computational resource for processing anonymously, wherein the provisioner is configured to provide a remaining part of the set of information, not being provided to the external computational resources, to the internal computational resources.

In a further embodiment, the method further comprises receiving the part of the set of information after being processed by the external computational resources and to decrypt the part of the set of information by the anonymizer.

In a further embodiment, the method further comprises receiving the computation requirements for the set of information from the mapper by the provisioner, establishing an interaction between the computational resources and the provisioner, identifying the resources available for processing the set of information by the provisioner based on the computational requirements, and generating the second list based on such identification and to provide the second list to the mapper.

### BRIEF DESCRIPTION OF THE DRAWINGS

Exemplary embodiments will be explained in more detail below on the basis of the schematic drawings, wherein:

FIG. 1 illustrates a schematic diagram of a computational resource allocation system; and

FIG. 2 illustrates a schematic diagram of a code analysis framework comprising a computational resource allocation system.

### DETAILED DESCRIPTION

Embodiment of the present disclosure are designed to allocate the computational resources between external computational resources and internal computational resources timely and cost effectively.

In an embodiment of a computational resource allocation system, the system includes a mapper and a provisioner for cost effectively allocating a set of information between external computational resources placed within an internet based computing environment and internal computational resources are at least part of a mega computational resource or placed in an intranet based computing environment. The mapper receives a first list representative of a set of information and a second list representative of a set of external computational resource and a set of internal computational resources, and further processes the first list to identify the computation requirements for computing the set of information and to map the computation requirements along with the set of information onto the set of resources by using the first list and the second list and generates an execution deployment plan comprising a part of the set of information to be sent to the external computational resources and another part of the set of information to be sent to the internal computational resources. The provisioner receives the execution deployment plan and provides the set of information to the computational resources in the set for processing of the set of information based on the execution deployment plan. This helps to utilize internal as well as external computational resources, thus helping to reduce the cost of processing the information, as along with the external resources, the internal resources are also being allocated.

In an alternate embodiment of the computational resource allocation system, the mapper maps the first list onto the second list for mapping the set of information by firstly mapping the first list onto the internal computational resources and further onto the external computational resources on exhausting the internal computational resources. This helps for more cost effective processing of the set of information, by limiting utilization of the external resources.

In yet alternate embodiment of the computational resource allocation system, the system includes an anonymizer which receive the execution deployment plan from the mapper, further processes the execution deployment plan and identifies a part of set of information to be sent to the external computational resources, encrypts the part of the set of information and sends the part of the set of information after encrypting to the provisioner for allocating the part of the set of information to the external computational resource for processing anonymously. The provisioner provides a remaining part of the set of information, not being provided to the external computational resources, to the internal computational resources. This makes the processing of the part of the set of information to be processed by the external computational resource secure.

In one embodiment of the computational resource allocation system, the anonymizer receives the part of the set of information after being processed by the external computational resources and decrypts the part of the set of information. This helps to converts the part of set of information in a format understandable by a proprietary framework of the user where the processed part of the information can be further used.

In an alternate embodiment of the computational resource allocation system, the provisioner receives the computation requirements for the set of information, interacts with the external computational resources and the internal computational resources, identifies the resources available for processing the set of information based on the computational requirements, generates the second list based on such identification and provides the second list to the mapper. This provides an easy way for provisioning of the computational resources.

In yet another embodiment of the computational resource allocation system, the internet based computing environment is cloud computing environment. This provides a systematic framework of external computational resources.

In an exemplary embodiment of the computational resource allocation system, the computational resource allocation system is a part of a code analysis framework, such that, the code analysis framework further includes a dependency module which receives a set of representations of various parts of a piece of code and determines interdependency based on at least control flow or data flow between various representations of the piece of code and collaborates the representations of parts of the piece of code into the set of information, wherein the computational resources processes the set of information to analyze the information for detecting violations of a set of rules. This provides a cost effective way to analyze the piece of code.

In one embodiment of the code analysis framework, the framework includes a representation module which receives the piece of code, divides the piece of code into various parts, generates representations for each part of the piece of code and provides the representations to the dependency module. This provides a self-contained framework which takes the piece of code as input and provides analysis of the piece of code as output.

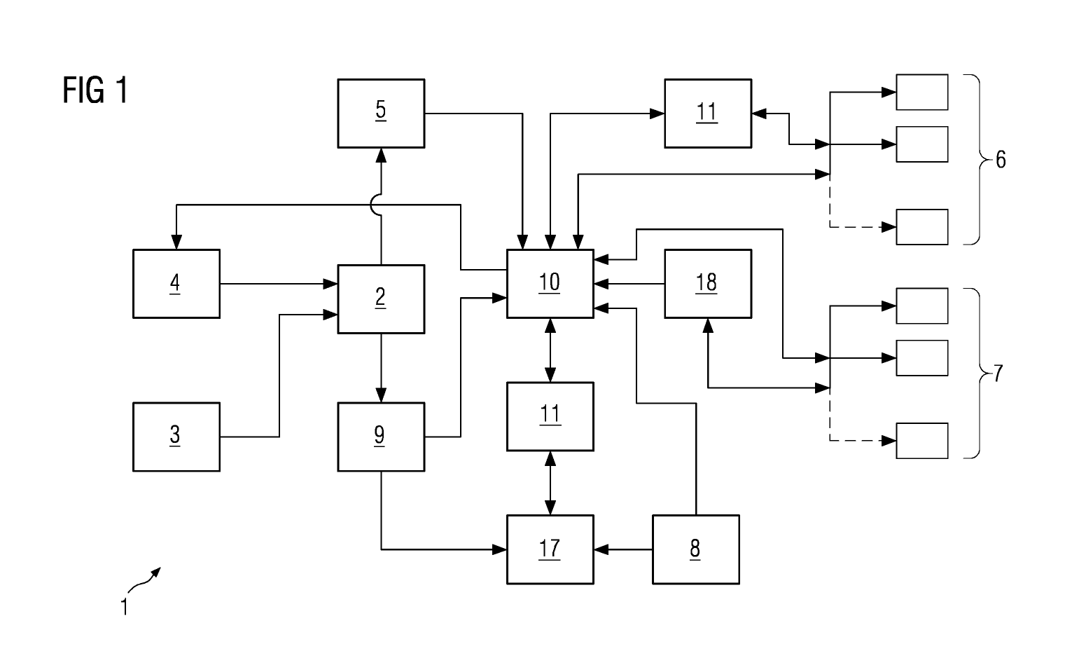

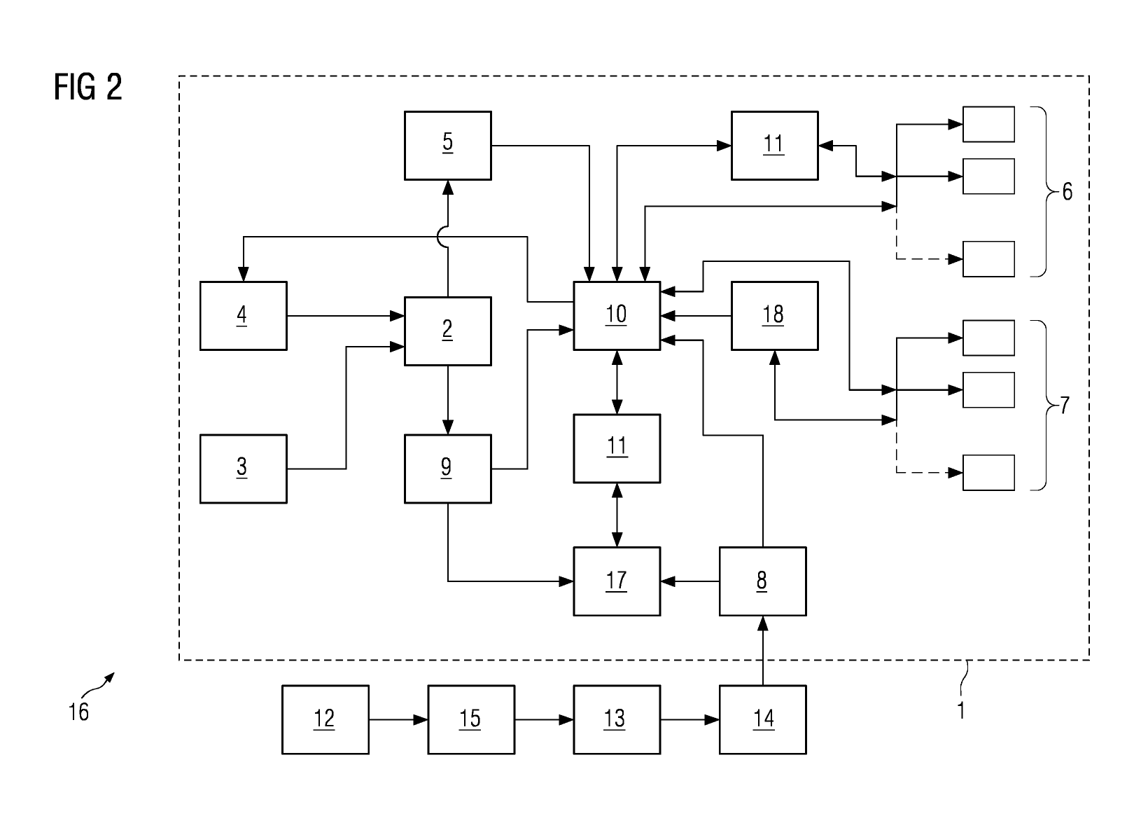

The embodiments herein and the various features and advantageous details thereof are explained more fully with reference to the non-limiting embodiments that are illustrated in the accompanying drawings (FIGS. 1 and 2) and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

Prior to explaining functioning of the system through various embodiments, some of the terminology used herein will be explained.

“Mapper”, “Provisioner” and “Anonymizer” are generally processors which are logic circuitry that responds to and processes the basic instructions for performing a function. They may be a central processing unit of a personal computer configured to perform the function or microprocessors which are multipurpose, programmable devices that accepts digital data as input, processes it according to instructions stored in its memory, and provides results as output or any other computing device configured to perform functions of the mapper and/or provisioner and/or anonymizer according to the current disclosure. However, technical difference between the mapper, the provisioner and the anonymizer are explained through there functionalities while explaining the figures.

“Computational resources” are quantification of computation effort required to process set information or solve a computation problem. A computational problem is generally defined in terms of its action on any valid input. Examples of problems might be “given an integer n, determine whether n is prime”, or “given two numbers x and y, calculate the product x*y”. As the inputs get bigger, the amount of computational resources needed to solve a problem will increase. Thus, the resources needed to solve a problem are described in terms of asymptotic analysis, by identifying the resources as a function of the length or size of the input. The simplest computational resources are computation time, the number of steps necessary to solve a problem, and memory space, the amount of storage needed while solving the problem, etc.

“Mega computational resource” is referred to a single computational resource having capability to process more amount of information in a set or capable of solving a bigger problem itself.

“Execution Deployment plan” is a plan mentioning about allocation of computational resources to various information in the set.

“Internet” is a global system of interconnected computer networks. It establishes a global data communications system between computational resources. For the purpose of this disclosure, the all the external computational resources are placed in the internet. The type of networking the internet supports are distributed systems, cloud computing, etc.

“Intranet” is a computer network that uses Internet Protocol technology to share information, operational systems, or computing services within an organization. More specifically, for the purpose of this disclosure, the intranet is a computer network of internal computational resources.

Explaining FIG. 1 and FIG. 2 together where the references will be made to each other.

According to FIG. 1, a resource allocation system 1 is illustrated having a mapper 2 and a provisioner which functions together to allocate a set of computational resources 6, 7 to a set of information 8.

The mapper 2 receives a first list 3 representative of a set of information 8 and second list 4 representatives of a set of external computational resource 6 and a set of internal computational resources 7. The mapper processes the first list 3 to identify the computation requirements 5 for computing the set of information 8 and maps the computation requirements 5 along with the set of information 8 onto the set of resources 6, 7 by using the first list 3 and the second list 4 for generating an execution deployment plan 9. The computational resources 6, 7 can be allocated in any fashion between information of the set 8. However, in some embodiments the mapper 2 maps the first list 3 onto the second list 4 by firstly mapping the first list 3 onto the internal computational resources 7 and further onto the external computational resources 6 on exhausting the internal computational resources 7.

The provisioner 10 receives the execution deployment plan 9 and provides the set of information 8 to the computational resources in the set 6, 7 for processing of the set of information 8 based on the execution deployment plan 9. The external computational resource 6 are placed in an internet based computing environment and the internal computational resources 7 are at least part of a mega computational resource or placed in an intranet based computing environment. The provisioner 10 also receives the computation requirements 5 for the set of information 8, interacts with the external computational resources 6 and the internal computational resources 7, identifies the resources 6, 7 available for processing the set of information 8 based on the computational requirements 5, generates the second list 4 based on such identification and to provide the second list 4 to the mapper 2. Alternately, the mapper 2 receives the first list 3 and the second list 4 from a user via an user interface.

The computational resource allocation system 1 further includes an anonymizer 17 which receives the execution deployment plan 9 from the mapper 2 and processes the execution deployment plan 9 for identifying a part 11 of set of information 8 to be sent to the external computational resources 6. The anonymizer 17 encrypts the part 11 of the set of information 8 and sends the part 11 of the set of information 8 after encrypting to the provisioner 10, wherein the provisioner 10 allocates the part 11 of the set of information 8 to the external computational resource 6 for processing anonymously. The provisioner 10 allocates a remaining part 18 of the set of information 8, not being provided to the external computational resources 6, to the internal computational resources 7. Alternatively, the system 1 need not have encrypting function, as there may be confidentiality relations already set up between the user and the external resources 6 owner or there may be a separate encryption or protection mechanism set up by the owner of the external computational resources 6.

The anonymizer 17 receives the part 11 of the set of information 8 after being processed by the external computational resources 6 and decrypts the part 11 of the set of information 8. Alternatively, the decryption function may not be required, as the system 1 and the proprietary framework of the user of the system 1 is able to understand and identify the processed set of information 8 without decrypting.

FIG. 2 is an illustration for a code analysis framework 16 having the computational resource allocation system of FIG. 1. The code analysis framework 1 further includes a dependency module 14 receives a set of representations 13 of various parts of a piece of code 12 and determines interdependency based on at least control flow or data flow between various representations 13 of the piece of code 12 and further collaborates the representations 13 of parts of the piece of code 12 into the set of information 8. The computational resources 6, 7 process the set of information to analyze the information 8 for detecting violations of a set of rules.

The code analysis framework 16 also includes a representation module 15 which receives the piece of code 12, divides the piece of code 12 into various parts, generates representations 13 for each part of the piece of code 12 and provides the representations 13 to the dependency module 14. The representation module 13 divides the piece of code based on either logical or physical correlation between various parts of the piece of code 12. In an alternate embodiment, the code analysis framework 16 need not require the representation module, as the framework 16 dependency module 14 receives the representations 13 of the parts of the piece of code 12 from a user via user interface.

The dependency module 14 and the representation module 15 are processing units of a processor which may be a microprocessor or a computer processing unit of a computer or any other such processor which are enabled to perform functions of dependency module 14 and the representation module 15. Technical difference between the dependency module 14 and the representation module 15 is already explained through the functionalities of the modules 14, 15 through the explanations of the FIG. 2.

In a specific implementation, the code analysis framework 16 is used for deep code analysis. Deep Static Code analysis tools are framework that runs on large server-grade machines which have mega computational resources. When the amount or length of the piece of code 12 is small this arrangement works well. However, this arrangement does not scale very well when the piece of code amount or length increases with passage of time.

Deep static code analysis, which is inter-procedural in nature, is expensive in terms of time because it essentially involves the following steps when executed in a structural analysis style, that is:

I. Flow analysis unit extraction (Gen Set, Kill Set, Data flow equations, Control flow graph)
II. Application of flow equations on analysis units for computation of flow details
III. Detection of applicable rule or guideline violations
IV. Report generation

The time taken for the steps I, II and III depends on the size of the piece of code 12 and even on a server-grade machine they take inordinate amounts of time (sometimes running for days). Consequently, software development projects either decrease the frequency of deep static analysis of code or do not perform deep static code analysis, instead restricting themselves to simple static code analysis techniques. Both of these approaches make the code susceptible to bugs that compromise the quality of software. Hence usage of the code analysis framework 16 of the FIG. 2 makes the whole process of deep code analysis efficient and cost effective.

To implement the deep code analysis using the code analysis framework, firstly the piece of code 12 is provided to a representation module 15 which divides the piece of code 12 into various parts and generate representations like Gen set, Kill set, Data flow equations, Control flow graph, etc. Further the first step of flow analysis is handled by the dependency module 14 which determine interdependency based on at least control flow or data flow between various representations 13 of the piece of code 12. The dependency module 14 collaborate the representations 13 of parts of the piece of code 12 into the set of information 8.

Further, the second step II of application of flow equations, i.e., the set of information 8 on computational resources 6, 7 for computation of flow details. While processing the flow equations, the computational resources 6, 7 detect applicable rule or guideline violations by the flow equations in the third step III.

In the last step iv, the processed set of information 8 is retrieved by the mapper 2 from the computational resources 6, 7 for generating the report.

Specifically, as step II and step III of the deep code analysis framework 16 requires huge computational resources 5, these steps are performed on external computational resources 6 beyond using the internal computational resources 7. However, step I and IV are specifically performed using the internal computational resources 7.

What is claimed is:

1. A computational resource allocation system comprising:
a mapper configured to:
receive a first list representative of a set of information and a second list representative of a set of external computational resource and a set of internal computational resources,
process the first list to identify the computation requirements for computing the set of information, and
map the computation requirements along with the set of information onto the set of resources by using the first list and the second list for generating an execution deployment plan,
a provisioner configured to:
receive the execution deployment plan, and
provide the set of information to the computational resources in the set for processing of the set of information based on the execution deployment plan,
wherein the external computational resource are placed in an internet based computing environment and the internal computational resources are at least part of a mega computational resource or placed in an intranet based computing environment.

2. The system of claim 1, wherein the mapper is configured to map the first list onto the second list for mapping the set of information by firstly mapping the first list onto the internal computational resources and further onto the external computational resources on exhausting the internal computational resources.

3. The system of claim 1, comprising:
an anonymizer configured to receive the execution deployment plan from the mapper, to process the execution deployment plan for identifying a part of set of information to be sent to the external computational resources, to encrypt the part of the set of information and to send the part of the set of information after encrypting to the provisioner for allocating the part of the set of information to the external computational resource for processing anonymously,
wherein the provisioner is configured to provide a remaining part of the set of information, not being provided to the external computational resources, to the internal computational resources.

4. The system of claim 3, wherein the anonymizer is configured to receive the part of the set of information after being processed by the external computational resources and to decrypt the part of the set of information.

5. The system of claim 1, wherein the provisioner configured to receive the computation requirements for the set of information from the mapper, to interact with the external computational resources and the internal computational resources, to identify the resources available for processing the set of information based on the computational requirements, to generate the second list based on such identification and to provide the second list to the mapper.

6. The system according to the claim 1, the external based computing environment is cloud computing environment.

7. A code analysis framework comprising:
a computational resource allocation system comprising:
a mapper configured to:
receive a first list representative of a set of information and a second list representative of a set of external computational resource and a set of internal computational resources,
process the first list to identify the computation requirements for computing the set of information, and
map the computation requirements along with the set of information onto the set of resources by using the first list and the second list for generating an execution deployment plan,
a provisioner configured to:
receive the execution deployment plan, and
provide the set of information to the computational resources in the set for processing of the set of information based on the execution deployment plan,
wherein the external computational resource are placed in an internet based computing environment and the internal computational resources are at least part of a mega computational resource or placed in an intranet based computing environment; and
a dependency module configured to receive a set of representations of various parts of a piece of code and configured to determine interdependency based on at least control flow or data flow between various representations of the piece of code and to collaborate the representations of parts of the piece of code into the set of information;
wherein the computational resources processes the set of information to analyze the information for detecting violations of a set of rules.

8. The framework of claim 7, further comprising a representation module configured to:
receive the piece of code,
divide the piece of code into various parts,
generate representations for each part of the piece of code, and
provide the representations to the dependency module.

9. A method for allocating computational resource, comprising:
receiving a first list representative of a set of information and a second list representative of a set of external computational resource and a set of internal computational resourcesby a mapper,
processing the first list to identify the computation requirements for computing the set of information,
mapping the computation requirements along with the set of information onto the set of resources by using the first list and the second list and generating an execution deployment plan based on the mapping by the mapper,
receiving the execution deployment plan from the mapper by a provisioner, and
providing the set of information to the computational resources in the set for processing of the set of information based on the execution deployment plan,
wherein the external computational resource are placed in an internet based computing environment and the internal computational resources are at least part of a mega computational resource or placed in an intranet based computing environment.

10. The method of claim 9, wherein mapping the first list onto the second list for mapping the set of information by firstly mapping the first list onto the internal computational resources and further onto the external computational resources on exhausting the internal computational resources.

11. The method of claim 9, comprising:
receiving the execution deployment plan from the mapper and processing the execution deployment plan for identifying a part of set of information to be sent to the external computational resources by an anonymizer, and
encrypting the part of the set of information and sending the part of the set of information after encrypting to the provisioner for allocating the part of the set of information to the external computational resource for processing anonymously,
wherein the provisioner is configured to provide a remaining part of the set of information, not being provided to the external computational resources, to the internal computational resources.

12. The method of claim 11, comprising:
receiving the part of the set of information after being processed by the external computational resources and to decrypt the part of the set of information by the anonymizer.

13. The method of claim 9, comprising:
receiving the computation requirements for the set of information from the mapper by the provisioner,
establishing an interaction between the computational resources and the provisioner,
identifying the resources available for processing the set of information by the provisioner based on the computational requirements, and
generating the second list based on such identification and to provide the second list to the mapper.
